(19) United States
(12) Patent Application Publication
(10) Pub. No.: US 2026/0022889 A1
(43) Pub. Date: Jan. 22, 2026

(54) HEATING FURNACE FOR A PLANT FOR THE PRODUCTION OF ROLLED PRODUCTS

(71) Applicant: Danieli & C. Officine Meccaniche S.P.A., Buttrio (UD) (IT)

(72) Inventors: Riccardo CONTE, RONCHI DEI LEGIONARI (GO) (IT); Alessandro DAPELO, Buttrio (UD) (IT); Andrea CODUTTI, MORUZZO (UD) (IT)

(21) Appl. No.: 19/099,021

(22) PCT Filed: Jul. 19, 2023
(86) PCT No.: PCT/IT2023/050169

§ 371 Date: Jan. 27, 2025

(30) Foreign Application Priority Data
Jul. 29, 2022 (IT) 102022000016248

(51) Int. Cl. F27B 9/02; B21B 45/00; F27B 9/36; F27D 11/02; F27D 11/06

(52) U.S. Cl. CPC F27B 9/02; B21B 45/00; F27B 9/36; F27D 11/02; F27D 11/06; F27B 2009/3638

(57) ABSTRACT

Heating furnace (10) for a plant (100) for the production of rolled products (P), wherein the heating furnace (10) comprises a tunnel (11) and a plurality of heating means (20). The heating means (20) comprise electrically powered heating elements (23, 24, 25).

### FIELD OF THE INVENTION

The present invention concerns a heating furnace for a plant for the production of rolled steel products, both flat such as plate or strip, and also long, such as bars, blooms, beam blanks, angle bars, or wire rod. The heating furnace can be used both in plants where the finished rolled products are obtained continuously, and also in plants where the finished rolled products are obtained discontinuously, for example starting from products cast in steps prior to rolling. The present invention also concerns a plant for the production of rolled products comprising said heating furnace.

### BACKGROUND OF THE INVENTION

Rolling plants are known, for the production of flat rolled steel products, or long rolled products, having a rolling line along which there is at least one heating furnace associated with one or more rolling units defining a rolling train. These heating furnaces are generally disposed at least upstream of the first rolling unit, also called roughing unit.

In endless rolling plants, unlike rolling plants which are separate from the casting, upstream of the rolling line there is a casting machine which continuously feeds a semi-finished steel product downstream. The product is generally cast in a vertical or semi-vertical direction, to then pass to a horizontal position thanks to a curved segment and to straightening elements. However, there are also vertical castings in which the product at exit, once completed, is overturned for the subsequent steps of the rolling process.

In other types of known rolling plants, the products can already be pre-cut to size once cast, to be fed hot or cold, discontinuously, onto a rolling line not directly connected to the casting, by means of suitable devices or transfer apparatuses.

An example of an endless rolling plant is described in the European patent EP 2.569.104 B1 in the name of the present Applicant.

Known endless rolling plants, whether they are designed for flat products or for long products, can carry out the rolling process in three different ways:
a continuous, or “endless” mode, in which the cast product, without being cut, is rolled continuously, and following the rolling it is cut and then wound to obtain rolls (in the case of flat products or long thin products such as wire), or it is cut and then stored/packaged (in the case of long products);
a “semi-endless” mode, in which an intermediate cut is made on the cast product between casting and rolling, so that the product to be rolled has an end of rolling length corresponding to an integer multiple, usually from two to ten, of the length of a single finished rolled product, and where the rolled product is again cut to size prior to winding, or storage;
and a discontinuous method, so-called “coil-to-coil” in the case of flat products or “billet-to-billet” in the case of long products (more generally batch), in which the cast product is cut to size before rolling in order to have an end of rolling length corresponding to the length of a single roll (coil-to-coil), or a single bar, or coil (billet-to-billet).

On the other hand, in rolling plants where casting is separate from rolling, the products to be rolled, such as slabs or billets, come from another plant, or from an off-line casting, and are fed to a zone upstream of the heating furnace. In these plants, the coil-to-coil or billet-to-billet mode is generally performed, to work on shorter and therefore more manageable products, and the products are usually rolled individually.

In other cases, especially in the field of long products, after the initial heating, the products are welded together, so as to be able to carry out an endless rolling, at the end of which the rolled product is separated again, or cut to size, according to the desired sizes, and is then collected.

In such known plants, whether they are endless or nor, the heating furnace can have a length comprised between about 60 m and about 150 m, but also 200-300 m, and it is shaped so as to define a tunnel. Inside the tunnel there is normally both a plurality of transport rollers to transport the product to be rolled toward the rolling train, and also a plurality of burners powered by fossil fuel, usually methane, to heat the product to be rolled.

In particular, a heating furnace is known that has an initial part, or section, which extends for about ⅓ of its total length, in which a greater heating power is supplied to the product to be rolled, so as to heat it rapidly, usually up to about 1,150-1,180° C. In the remaining part of the heating furnace, also known as the maintenance part or section, the heating power is reduced, but is still sufficient to allow the temperature to be maintained and equalized for the subsequent rolling.

It is also known that in endless rolling plants, one or more heating devices are present between the roughing stands and the finishing stands of the train.

In the case of endless and semi-endless rolling, the distance between the section of the roughing stands and the section of the finishing stands is in a compact configuration, that is, in a configuration according to which the product exiting the roughing stands is engaged in the finishing stands after a few meters. Rolling therefore takes place in a so-called “tandem” mode, in which the semi-rolled product is engaged between head and tail at the same time in the roughing stands and in the finishing stands for almost the entire process.

In particular, since the transit speed of the semi-rolled product is high and the space between the roughing and finishing stands is small, the transit time of the product is short, and consequently the heating devices are normally inductors able to supply a high heating power in a very short time.

On the contrary, in the case of batch-to-batch rolling, the distance between the section of the roughing stands and the section of the finishing stands can even reach 150 m. In particular, a heating section known as the Heated Transfer Table (HTT) is normally installed between the two sections. The semi-rolled product exiting the roughing stands is totally contained in the HTT and the rolling in the finishing stands begins when the rolling in correspondence with the roughing stands has ended.

Since stay times in the HTT and transit times are higher than in the conditions of endless and semi-endless rolling, the heating of the semi-rolled product takes place by means of fossil fuel burners, with a consequent production of emissions. Moreover, known heating furnaces, along their longitudinal development, comprise both so-called “active” parts or sections provided with heating elements, for example burners, or possibly inductors, in order to heat the product to be rolled, and also so-called “passive” parts or sections, alternating with the active parts, made of refractory material and lacking heating elements since it is not necessary to add additional heat, but to ensure that the accumulated heat is distributed. Generally, the passive parts are found in the last ⅔ of the length of the heating furnace, or possibly in the last ⅓.

One disadvantage of known heating furnaces is that the use of burners to heat the products to be rolled entails a considerable consumption of methane, or other fossil fuels, thus implying high production costs.

Another disadvantage is that the use of fossil fuel burners entails the emission of large quantities of carbon dioxide (CO₂) and other combustion gases for tens of thousands of tons a year, which have to be suitably treated in order to impact the atmosphere as little as possible and which, in addition, entail high costs related to “carbon tax” which in some cases can have a heavy impact on company budgets. Furthermore, heating furnaces with fossil fuel burners have low energy efficiency, since approximately 60% of the heating power is lost in the fumes that are generated inside the tunnel and in the contact between the product to be rolled and the transport rollers.

Among the known documents there is GB 420 485 A which describes a heating furnace for pipes, consisting of two longitudinal sections of comparable size to each other, and an overall length much shorter than conventional furnaces with a heating and maintenance tunnel for the production of rolled products. This furnace provides to use, in its various sections, electric induction heating means, and resistive type electric means.

This type of furnace provides to work horizontally or inclined, and can be filled with neutral or reducing gases which are lighter than air, to obtain polished pipes at exit. Heating means using gas or other fuel can also be used inside the furnace and the temperatures reached inside are much lower than the temperatures reached in the heating and maintenance furnaces for the production of rolled products.

Document DE 195 18 144 A1 is also known, which describes a heating furnace interposed between two successive rolling trains and provided with longitudinal sections substantially having a ratio in length of 1:1. In an initial zone of the rolling mill there are electric heating means, in particular induction; downstream of the latter there are heating means of another type. The rolling mill is provided with so-called passive sections, that is, consisting of isolated zones lined with refractory material which serve to maintain and standardize the heat of the product passing through it, but without adding additional heat.

Document DE 102011004245 A1 describes a heating furnace for metal products in which, in correspondence with an entry longitudinal section, there are induction electric heating means, and in a longitudinal section downstream, much longer than the entry one, there are heating means using gas or other fossil fuels, which allow to reach temperatures even higher than 1,000° C.

Document US 2015/321232 is also known, which describes an apparatus for rolling an aluminum sheet, in which a roller is used to roll up said sheet while it is hot. The apparatus comprises heating means which can be gas, or other fossil fuel, electric induction means, or electric of the resistive type. The temperatures reached in this apparatus are much lower than the temperatures reached in the heating furnaces for the production of rolled products as described above.

There is therefore a need to perfect a heating furnace intended for a plant for the production of rolled products, which can overcome at least one of the disadvantages of the state of the art.

To do this, it is necessary to solve the technical problem of heating the product to be rolled efficiently and economically inside the heating furnace, without using fossil fuels, in particular methane.

One purpose of the present invention is to provide a heating furnace for a plant for the production of rolled products which is highly efficient, and which is able to eliminate the consumption of fossil fuels and the consequent polluting emissions.

Another purpose of the present invention is to provide a heating furnace for a plant for the production of rolled products which is able to at least replicate the heating characteristics of heating furnaces in the state of the art.

Another purpose of the present invention is to provide a heating furnace for a plant for the production of rolled products which allows to obtain clear savings in terms of energy and costs.

The Applicant has devised, tested and embodied the present invention to overcome the shortcomings of the state of the art and to obtain these and other purposes and advantages.

### SUMMARY OF THE INVENTION

The present invention is set forth and characterized in the independent claims. The dependent claims describe other characteristics of the present invention or variants to the main inventive idea.

In accordance with the above purposes, and to resolve the technical problem disclosed above in a new and original way, also achieving considerable advantages compared to the state of the prior art, the invention concerns a heating furnace for a plant for the production of rolled products, wherein the heating furnace comprises a tunnel and a plurality of heating means.

In accordance with one aspect of the present invention, the heating means comprise inductive type electric heating elements and resistive type electric heating elements, wherein the inductive type electric heating elements are disposed at least in an entry zone to the tunnel and the second resistive type electric heating elements are disposed in the tunnel downstream of the inductive type electric heating elements at entry. In particular, the inductive type electric heating elements disposed in the entry zone are configured to bring the temperature of the rolled products to a value of at least 1,100° C. This temperature also serves the purpose of keeping the alloying elements in solution.

Doing so achieves at least the advantages of eliminating both the consumption of fossil fuels, such as methane, and also the corresponding production of carbon dioxide CO2 and other combustion gases.

In accordance with another aspect of the present invention, the heating furnace comprises at least a first zone in correspondence with an entry end thereof, in which there is at least a first plurality of the inductive type heating elements, and a second zone located downstream of the first zone in the direction of advance of the product to be rolled, in which there is a first plurality of the resistive type heating elements.

According to preferred embodiments, the first plurality of inductive type heating elements, disposed in the first zone, are of the longitudinal flow type.

In accordance with another aspect of the present invention, a pre-rolling temperature in the tunnel is comprised between about 1,250° C. and about 1,300° C. Moreover, the first zone has a first length such that the first plurality of the inductive type heating elements is configured to bring the product to be rolled to the pre-rolling temperature by using a determinate nominal peak power comprised between about 10 MW and about 60 MW.

In particular, each inductive type heating element is able to preferentially deliver a power of about 6 MW.

In accordance with another aspect of the present invention, the heating furnace has an overall length preferably comprised between about 20 m and about 300 m, even more preferably between about 40 m and about 180 m, wherein the first zone has a first length such as to occupy at least ⅕ of the overall length.

In accordance with another aspect of the present invention, the second zone has a second length greater than the first length and such that the second resistive type heating elements are configured to maintain and equalize the product to be rolled at a maintenance temperature which is substantially equal to, or slightly lower than, the pre-rolling temperature, by actively supplying a determinate second power comprised between about 2 MW and about 16 MW.

In accordance with another aspect of the present invention, the second zone comprises at least one movable part able to be moved between a closed position and an open position in which it allows to introduce the products to be rolled coming from another production line into the tunnel.

In accordance with another aspect, the second zone has a length and a heating capacity sized and optimized as a function of the ability to act as a buffer for the rolled products in the steps of changing the rolling cylinders, or for maintenance operations. In other words, the resistive heating means are configured to supply a heat input such that the rolled product can be stopped for the time necessary to carry out said operations on the cylinders, while in any case maintaining the pre-rolling temperature disclosed above.

In accordance with another aspect of the present invention, the heating furnace also comprises a third zone located downstream of the second zone in the direction of advance of the product to be rolled, and in which there is at least a second plurality of the inductive type electric heating elements. The third zone has a third length such that the second plurality of the inductive type heating elements is configured to bring the product to be rolled to a maximum value of the pre-rolling temperature, as a function of the mode used (endless or coil-to-coil) by using a determinate third power comprised between about 6 MW and about 30 MW.

The third zone is particularly advantageous and useful for reaching the optimal thermal target for endless rolling, which requires average temperatures of the product to be rolled of about 1,180° C.±30° C., to which corresponds a surface temperature thereof of about 1250° C.±30° C.

In accordance with another aspect of the present invention, it is also possible to provide a fourth zone which is disposed downstream of the third zone in the direction of advance of the product to be rolled and which comprises a second plurality of resistive type heating elements. In particular, the fourth zone has a fourth length such that the second plurality of resistive type heating elements is configured to maintain and equalize the temperature of the product to be rolled reached in the third zone, by supplying a determinate fourth heating power comprised between about 2 MW and about 8 MW.

The tunnel comprises a plurality of consecutive internal insulating panels capable of withstanding the pre-rolling temperature.

In accordance with another aspect of the present invention, the resistive type heating elements are disposed side by side, or adjacent, to each other, so as to affect at least ½ of the internal cross-section of the tunnel.

Furthermore, the resistive type heating elements are preferably disposed above and/or below the product to be rolled, and possibly also on the sides of the latter so as to be interposed between the internal surface of the tunnel and the product to be rolled.

In accordance with another aspect of the present invention, the resistive type heating elements are disposed perpendicularly to the direction of advance of the product to be rolled.

In accordance with another aspect of the present invention, a plant for the production of rolled products comprises at least one rolling train and a heating furnace as described above, which is disposed, along a rolling line, upstream of the rolling train.

In accordance with another aspect of the present invention, the plant comprises, upstream of the heating furnace, a casting machine to continuously feed a product to be rolled, wherein the plant is able to execute the rolling process at least in continuous, that is, endless, mode.

In accordance with another aspect of the present invention, the plant comprises, along the rolling line, a pendulum shear that is disposed between the casting machine and the heating furnace, to cut to size the product to be rolled fed continuously, whereby the plant is able to also execute the rolling process in semi-endless mode, coil-to-coil mode in the case of flat products, or billet-to-billet mode in the case of long products.

In accordance with another aspect of the present invention, along the rolling line, a feed apparatus is disposed upstream of the heating furnace in order to cold feed the product to be rolled, and the rolling train comprises a plurality of roughing stands, disposed close to the heating furnace and a plurality of finishing stands disposed downstream of the roughing stands. The plant comprises another heating furnace, as described above, disposed between the roughing stands and the finishing stands.

### DESCRIPTION OF THE DRAWINGS

These and other aspects, characteristics and advantages of the present invention will become apparent from the following description of some embodiments, given as a non-restrictive example with reference to the attached drawings wherein:

FIG. 1 is a schematic representation of a plant for the production of rolled products in which there is a heating furnace according to the present invention;

FIG. 2 is a schematic representation of a plant for the production of rolled products according to another embodiment in which there is a heating furnace of FIG. 1;

FIG. 3 is a schematic representation of a part of a plant for the production of rolled products according to another embodiment, in which a heating furnace according to the present invention is shown in greater detail;

FIG. 4 is a schematic perspective view of the heating furnace according to the present invention, in correspondence with a first and a third operating zone;

FIG. 5 is a schematic perspective view of the heating furnace according to another embodiment of the present invention, in correspondence with the first and third operating zone;

FIG. 6 is a schematic section view of the heating furnace according to the present invention, in correspondence with a second operating zone;

FIG. 7 is a schematic section view of the heating furnace according to another embodiment of the present invention, in correspondence with the second operating zone;

FIG. 8 is a schematic section view of the heating furnace according to another embodiment of the present invention, in correspondence with the second operating zone;

FIG. 9 is a schematic representation of the heating furnace according to the present invention;

FIG. 10 is a qualitative diagram which shows the relationship between heating power and length of the heating furnace of FIG. 9;

FIG. 11 is a qualitative diagram which shows the relationship between the average pre-rolling temperature and the length of the heating furnace of FIG. 9, when coil-to-coil or semi-endless rolling is performed;

FIG. 12 is a qualitative diagram which shows the relationship between the pre-rolling surface temperature and the length of the heating furnace of FIG. 9, when coil-to-coil or semi-endless rolling is performed;

FIG. 13 is a schematic representation of the heating furnace according to another embodiment of the present invention;

FIG. 14 is a qualitative diagram which shows the relationship between the heating power and the length of the heating furnace of FIG. 13;

FIG. 15 is a qualitative diagram which shows the relationship between the average pre-rolling temperature and the length of the heating furnace of FIG. 13, when an endless rolling is performed;

FIG. 16 is a qualitative diagram which shows the relationship between the pre-rolling surface temperature and the length of the heating furnace of FIG. 13, when an endless rolling is performed.

We must clarify that in the present description the phraseology and terminology used, as well as the figures in the attached drawings also as described, have the sole function of better illustrating and explaining the present invention, their function being to provide a non-limiting example of the invention itself, since the scope of protection is defined by the claims.

To facilitate comprehension, the same reference numbers have been used, where possible, to identify identical common elements in the drawings. It is understood that elements and characteristics of one embodiment can be conveniently combined or incorporated into other embodiments without further clarifications.

### DESCRIPTION OF SOME EMBODIMENTS OF THE PRESENT INVENTION

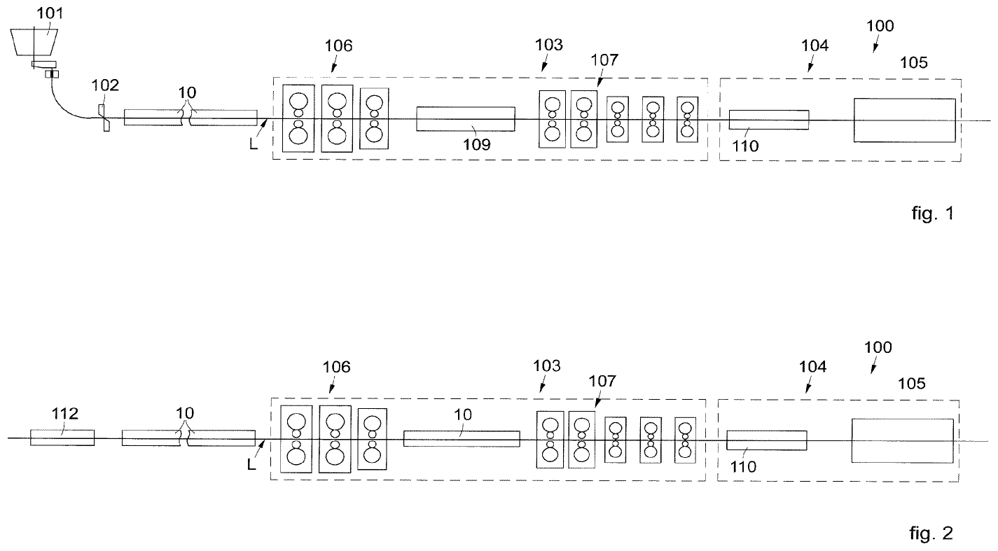

With reference to FIG. 1, a heating furnace 10 according to the present invention is suitable to be used in a plant 100 for the production of finished rolled products which can be flat or long, as defined above.

In the embodiment shown in FIG. 1, the plant 100 is an endless rolling plant and it is configured to perform the rolling process according to several known modes: a continuous mode, also called endless; a semi-endless mode; and a discontinuous mode, also called coil-to-coil in the case of flat products, or billet-to-billet in the case of long products.

The plant 100 for rolled products comprises a rolling line L upstream of which there is disposed a casting machine 101 to continuously feed a product P to be rolled, for example a slab in the case of flat products or a billet, a bloom, or a beam blank in the case of long products.

In particular, along the rolling line L there can be disposed in sequence a pendular shear 102 (FIG. 1) configured to cut to size the product to be rolled in case the semi-endless or coil-to-coil/billet-to-billet rolling modes are to be performed, a heating furnace 10 and a rolling train, or unit, 103. In the terminal part of the rolling line L there is a winding/unloading zone 104, of a known type, in which the rolled products pass for example through a laminar cooling device 110 and are then wound/unloaded in plate, possibly passing in advance through a terminal zone 105, schematized with a rectangular element in FIGS. 1 and 2, in order to be suitably cut to size.

The hot rolling train 103 comprises a plurality of rolling stands of a known type, disposed in succession and each provided with a plurality of rollers configured to perform the rolling of the product to be rolled. The rolling stands are divided into roughing stands 106, which are disposed close to the heating furnace 10, and finishing stands 107, which are disposed downstream of the roughing stands 106. In addition, according to other embodiments not shown in the drawings, intermediate stands, substantially of a known type and not shown in the drawings, can also be provided between the roughing stands 106 and the finishing stands 107. The use of such intermediate stands is particularly suitable if rolling long products, where even twenty or more rolling stands can be present. If rolling flat products, however, the number is usually between six and twelve rolling stands.

Between the roughing stands 106 and the finishing stands 107 there can be a heating device 109, preferably induction electric, to return the partly rolled product to a correct temperature, since the latter tends to cool during the rolling process.

In accordance with another embodiment, shown in FIG. 2, the plant 100 is without the casting machine 101 and the pendulum shear 102 and it comprises, upstream of the heating furnace 10, along the rolling line L, a feed apparatus 112 to cold or hot feed the product P to be rolled. In this case, the plant 10 is configured to execute the rolling process only in semi-endless and/or coil-to-coil modes; in fact, along the rolling line L the product to be rolled is fed in a discontinuous manner.

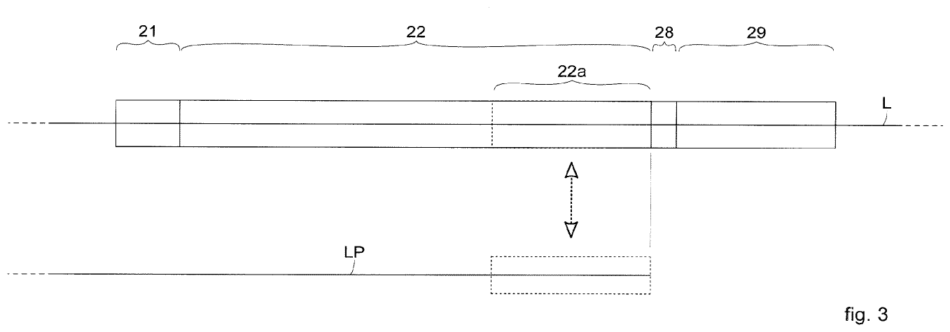

Furthermore, as shown in FIG. 3, the plant 100 can also comprise another production line LP disposed parallel to the rolling line L and along which other products P to be rolled can be fed.

The heating furnace 10 is conformed in such a way as to define a tunnel 11 having an entry end 12 through which it is possible to introduce at least one product P to be rolled, and an exit end 13 opposite the entry end 12 and facing toward the rolling train 103. The heating furnace 10 preferably has a length comprised between about 20 m and about 300 m, even more preferably between about 40 m and about 180 m (FIG. 3).

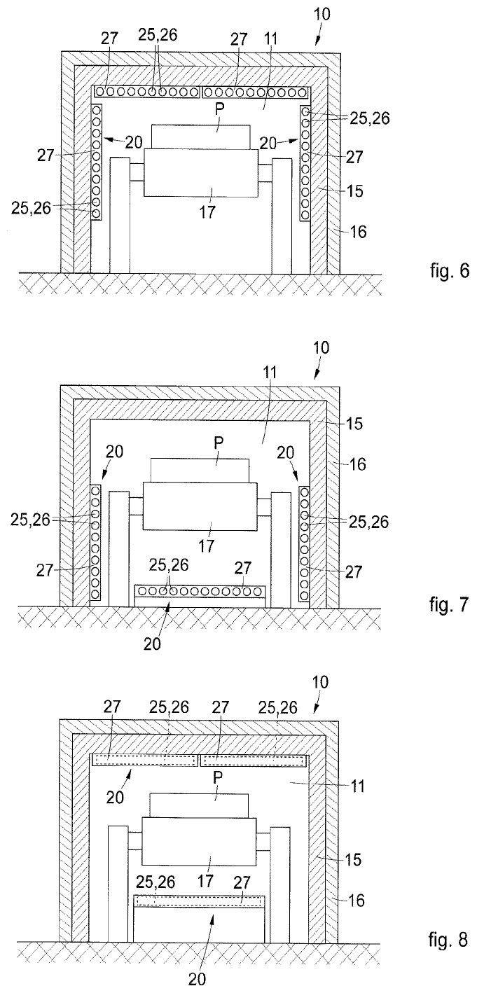

The structure of the heating furnace 10 is substantially of a known type, specifically the tunnel 11 (figs. from 4 to 8) is formed by a plurality of consecutive modules associated with each other which, for example, can each comprise internal or cladding insulating panels 15 which are able to withstand high temperatures, for example higher than about 1,300° C., and cooled panels 16 external to the insulating panels 15 (FIGS. 5 and 6) and substantially of a known type. Preferably, in the case of flat products the tunnel 11 has a substantially rectangular internal cross-section, while in the case of long products the internal section is substantially square.

Inside the tunnel 11 there is a plurality of transport elements 17, defined for example by rollers, which are configured to make the product P to be rolled advance from the entry end 12 to the exit end 13.

The transport elements 17 are preferably of the so-called “dry” type, that is, they are not provided with an internal cooling; specifically, they can be made of a metal superalloy, preferably consisting of between about 40% and 50% Nickel (Ni), between about 25% and 35% Cobalt (Co) and between about 25% and 35% Chromium (Cr). It is understood that according to other embodiments of the present invention the transport elements 17 can be conventional cooled rollers.

In accordance with one aspect of the present invention, the heating furnace 10 comprises a plurality of heating means 20 of the electrically powered type, which are disposed inside the tunnel 11 in order to heat the product P to be rolled and/or maintain it at a determinate pre-rolling temperature. The pre-rolling temperature is comprised between about 1,250° C. and 1,300° C.

The heating means 20 comprise inductive type electric heating elements 23, 24 and resistive type electric heating elements 25, 26, wherein the inductive type electric heating elements 23 are disposed in an entry zone of the tunnel 11 and the resistive type electric heating elements 25 are disposed in the tunnel 11 downstream of the inductive type electric heating elements 23.

In particular, the inductive type electric heating elements 23, disposed in correspondence with the entry zone of the tunnel 11, are configured to bring the temperature of the rolled, or to be rolled, products to a value of at least 1,100° C.

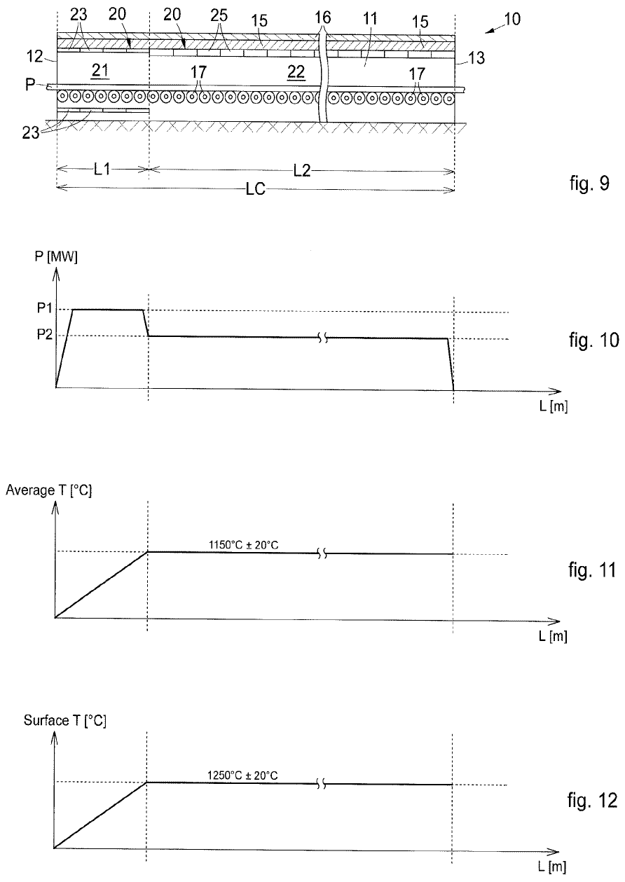

In accordance with another aspect of the present invention, the heating furnace 10 comprises at least a first zone 21 (FIGS. 3, 9 and 13), or inductive heating zone, which extends from the entry end 12 for about ⅕ of the total length LC of the tunnel 11, and a second zone 22, or active maintenance zone, located downstream of the first zone 21 in the direction of advance of the product P to be rolled.

The first zone 21 has a first length L1 and it is provided with a first plurality of inductive type electric heating elements 23 which is configured to bring the product P to be rolled to the heating temperature by using a determinate first heating power P1 comprised between 6 MW and 48 MW (FIG. 10). By way of example, the first length L1 is about 10 m.

In general, the inductive type electric heating elements 23, 24 can use a longitudinal or transverse flow induction system, or a combination thereof; wherein the terms “longitudinal” and “transverse” are considered with respect to the direction of advance of the product P to be rolled.

Advantageously, the first plurality of inductive type electric heating elements 23, that is, those disposed in correspondence with the entry zone of the tunnel 11, is of the longitudinal flow type.

Please note that this longitudinal flow induction system is able to mainly heat the external part of the product P to be rolled, thus preparing it for the subsequent maintenance/heating by means of the resistive type elements 25, 26, which occurs for an amount of time sufficient for a redistribution by conduction over the entire section of the product P of the heat generated by them to occur.

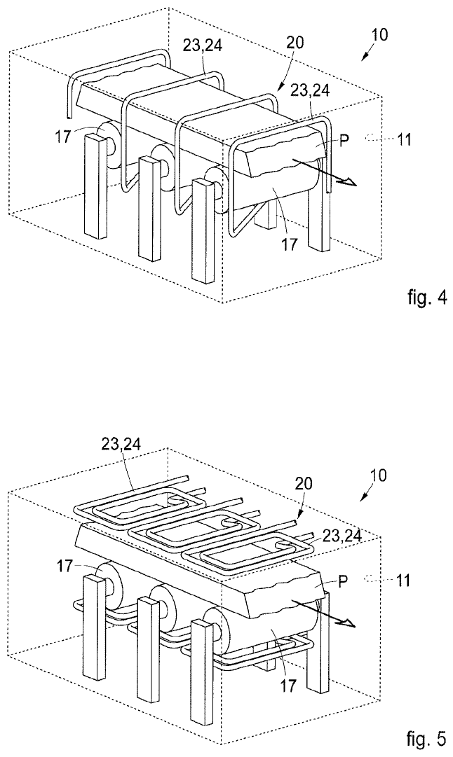

In particular, in the case of a longitudinal flow induction system the inductive type electric heating elements 23, 24 are provided with coils disposed around the product P to be rolled (FIG. 4); instead, in the case of a transverse flow induction system, the coils are disposed straddling the product P to be rolled (FIG. 5), that is, above and below the latter.

For example, each inductive type heating element 23, 24 is capable of supplying a power of about 6 MW.

The second zone 22 has a second length L2 (FIGS. 3, 9 and 13) and is provided with a plurality of resistive type electric heating elements 25, such as resistors, heat resistors or suchlike, which are configured to maintain and equalize the temperature of the product P to be rolled at a maintenance temperature TM that is substantially equal to, or slightly lower than, the pre-rolling temperature TP, actively supplying a determinate second heating power P2 comprised between 2 MW and 16 MW (FIG. 10).

The length of the second zone 22 is sized, in an optimized manner, to allow the maintenance of the rolling train 103 without having to interrupt the operation of the heating furnace 10. In other words, the heat supplied by the resistive type elements 25 is such as to allow the furnace to function as a buffer in the event that the product has to be stopped for operations to replace or maintain the cylinders.

In the second zone 22, the resistive type elements 25 actively supply heat to the product P to be rolled, heating it or maintaining it so that it maintains a temperature that is suitable for the subsequent rolling. For example, the maintenance temperature TM of the product to be rolled can be considered both in terms of average temperature (FIG. 11) and also in terms of surface temperature (FIG. 12), and it is about 1.150±20° C. in the case of average temperature and about 1.250° C.±20° C. in the case of surface temperature. By way of example, the second length L2 is comprised between about 70 m and about 80 m. Specifically, the resistive type electric heating elements 25 are preferably made of a specific metal alloy, rather than a ceramic alloy, which is able to withstand the pre-rolling temperature and the vibrations related to the transport of the product P to be rolled. Preferably, the metal alloy is a Resisthom alloy (FeCrAl). As seen in FIG. 10, the first power P1 supplied in the first zone 21 by the inductive type electric heating elements 23 is greater than the second power P2 supplied in the second zone 22 by the resistive type electric heating elements 25. For example, the resistive type electric heating elements 25, 26 are disposed on respective support panels 27 (FIGS. 5 and 6); wherein each support panel 27 comprises a plurality of resistive type electric heating elements 25, 26.

In particular, the resistive type electric heating elements 25 and 26 are disposed side by side, or adjacent, to each other so as to affect at least ½ of the internal cross-section of the tunnel 11. Preferably, the resistive type electric heating elements 25, 26 are positioned on the upper internal wall, that is, on the ceiling, and on the sides of the tunnel 11 and are disposed so as to lie substantially parallel with respect to the direction of advance of the product P to be rolled (FIG. 6). According to another embodiment, shown in FIG. 7, the resistive type electric heating elements 25, 26 are positioned on the bottom wall, that is, on the bottom, and/or on the sides of the tunnel 11. In this case, each resistive type electric heating element 25, 26 disposed below the product P to be rolled can be protected through metal encapsulation, for example by means of radiant tubes, in order to prevent the triggering of short circuits between adjacent resistive type electric heating elements 25, 26, due to the falling of scales of the product P to be rolled transported by the transport elements 17.

As shown in FIG. 8, the resistive type electric heating elements 25, 26 can be disposed above and below the product P to be rolled and oriented differently from what is shown in FIG. 6, that is, in such a way as to be substantially perpendicular to the direction of advance of the product P to be rolled.

In general, as shown in FIGS. 6, 7 and 8, the resistive type electric heating elements 25, 26 are substantially interposed between the internal surface of the tunnel 11 and the product P to be rolled.

Moreover, thanks to the presence of the resistive type electric heating elements 25, 26 along the second zone 22, there is the advantage that there are no so-called “passive” parts, normally created in the heating furnaces of the state of the art, which are limited to maintaining the temperature of the material, since they consist of refractory material.

By way of example, between two and five heating means 20 per square meter can be disposed inside the tunnel 11.

The second zone 22 is advantageously provided with at least one movable part 22a able to be moved between a closed position and an open position in which it allows to introduce into the tunnel 11 products P to be rolled coming from another production line LP (FIG. 2). Preferably, the movable portion 22a corresponds to a terminal part of the second zone 22.

By way of example, the movable part 22a has a length comprised between about 25 m and about 30 m.

The disposition of the resistive type electrical heating elements 25 in the movable part 22a has the advantage that the movement of the latter is much simpler than in the state of the art.

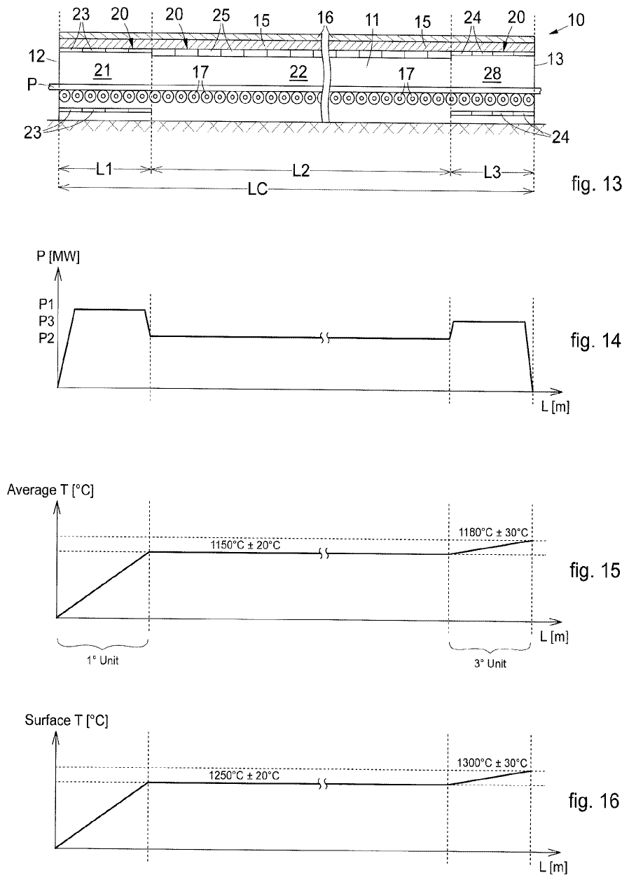

In accordance with another embodiment, shown in FIG. 13, the heating furnace 10 comprises a third zone 28, also for inductive heating, located downstream of the second zone 22 with respect to the direction of advance of the product P to be rolled and in which there is at least a second plurality of the inductive type electric heating elements 24. The third zone 28 has a third length L3 such that the second plurality of inductive type electric heating elements 24 is configured to bring the product P to be rolled to a maximum value of the pre-rolling temperature TP, by using a determinate third heating power P comprised between 6 MW and 30 MW (FIG. 14). By way of example, the first length L1 is about 5 m.

The third zone 28 is particularly advantageous in the case of endless rolling, which requires an average temperature of the product P to be rolled of about 1.180° C.±30° C. (FIG. 15), to which corresponds a surface temperature thereof of about 1.300° C.±30° C. (FIG. 16).

As seen in FIG. 14, the first and the third power P1 and P3 generated in the first and in the third zone 21 and 28 by the inductive type electric heating elements 23 and 24 are greater than the second power P2 generated in the second zone 22 by the resistive type electric heating elements 25. We must clarify that the first and third power P1 and P3 may be different from each other, or may not be constant along the respective length L1 and L3 of the first and, respectively, the third zone 21 and 28. Furthermore, the power P2 may have a non-constant value along the length L2 of the second zone 22.

In accordance with another embodiment, not shown in the drawings, also the third zone 28, or at least a part thereof, is movable between a closed position and an open position, to allow to introduce into the tunnel 11 products P to be rolled coming from other production lines.

Furthermore, as shown in FIG. 3, according to another embodiment of the present invention, the heating furnace 10 also comprises a fourth zone 29 which is disposed downstream of the third zone 28 in the direction of advance of the product to be rolled.

The fourth zone 29 has a fourth length L4 (FIG. 3) and is provided with a second plurality of resistive type electric heating elements 26 which are configured to maintain and equalize the temperature of the product P to be rolled reached in the third zone 28, by supplying a determinate fourth heating power P4 comprised between about 2 MW and about 8 MW.

By way of example, the fourth length L4 is comprised between about 25 m and about 30 m.

In accordance with the embodiment of FIG. 2, the heating furnace 10 can be disposed not only upstream of the rolling train 103, but also between the roughing stands 106 and the finishing stands 107.

The use of electrically powered heating elements 20 has the advantage of eliminating the consumption of fossil fuels and, consequently, of eliminating polluting emissions of CO₂ and other flue gases.

This allows for considerable economic savings on the plant costs, also considering the maintenance costs of the heating elements 20. In fact, thanks to electric operation, it is no longer necessary to pay the carbon tax due to polluting emissions in full.

It is clear that modifications and/or additions of parts may be made to the heating furnace 10 as described heretofore, without departing from the field and scope of the present invention, as defined by the claims.

It is also clear that, although the present invention has been described with reference to some specific examples, a person of skill in the art will be able to achieve other equivalent forms of heating furnaces for a plant for the production of rolled products, having the characteristics as set forth in the claims and hence all coming within the field of protection defined thereby.

In the following claims, the sole purpose of the references in brackets is to facilitate their reading and they must not be considered as restrictive factors with regard to the field of protection defined by the very claims.

1. Heating furnace for a plant for the production of rolled products, wherein said heating furnace comprises a tunnel and a plurality of heating means, characterized in that wherein said heating means comprise inductive type electric heating elements and resistive type electric heating elements, wherein said inductive type electric heating elements are disposed at least in an entry zone to said tunnel and said second resistive type electric heating elements are disposed in said tunnel downstream of said inductive type electric heating elements at entry, wherein said inductive type electric heating elements disposed in said entry zone are configured to bring the temperature of said rolled products to a value of at least 1,100° C.

2. Heating furnace as in claim 1, wherein it comprises at least a first zone in correspondence with an entry end thereof, in which there is at least a first plurality of said inductive type heating elements, and a second zone located downstream of said first zone in the direction of advance of said product to be rolled, in which there is a first plurality of said resistive type heating elements.

3. Heating furnace as in claim 2, wherein said first plurality of said inductive type heating elements is of the longitudinal flow type.

4. Heating furnace as in claim 2, wherein a pre-rolling temperature in said tunnel is comprised between about 1,250° C. and about 1,300° C., and wherein said first zone has a first length such that said first plurality of said inductive type heating elements is configured to bring said product to be rolled to said pre-rolling temperature by using a determinate first power comprised between about 6 MW and about 48 MW.

5. Heating furnace as in claim 4, wherein it has an overall length comprised between about 20 m and about 300 m, wherein said first zone has a first length such as to occupy at least ⅕ of said overall length.

6. Heating furnace as in claim 2,
wherein a pre-rolling temperature in said tunnel is comprised between about 1,250° C. and about 1,300° C., and wherein said first zone has a first length such that said first plurality of said inductive type heating elements is configured to bring said product to be rolled to said pre-rolling temperature by using a determinate first power comprised between about 6 MW and about 48 MW, and
wherein said second zone has a second length greater than said first length and such that said first plurality of said resistive type heating elements is configured to maintain and equalize the product to be rolled at a maintenance temperature, which is substantially equal to, or slightly lower than, said pre-rolling temperature, by supplying a determinate second power comprised between about 2 MW and about 16 MW.

7. Heating furnace as in claim 6, wherein said second zone comprises at least one movable part able to be moved between a closing position and an opening position in which it allows to introduce said products to be rolled coming from another production line into said tunnel.

8. Heating furnace as in claim 6, wherein said second length is such as to allow said second zone to perform a buffer function for said product to be rolled without losing temperature in the event of operations for changing or maintenance of the rolling cylinders.

9. Heating furnace as in claim 6, wherein it also comprises a third zone located downstream of said second zone in the direction of advance of said product to be rolled and in which there is at least a second plurality of said inductive type electric heating elements, and in that said third zone has a third length such that said second plurality of said inductive type heating elements is configured to bring said product to be rolled to a maximum value of said pre-rolling temperature by using a determinate third power comprised between about 6 MW and about 30 MW.

10. Heating furnace as in claim 9, wherein it possibly also comprises a fourth zone located downstream of said third zone in the direction of advance of said product to be rolled and in which there is at least a second plurality of said resistive type electric heating elements, and in that said fourth zone has a fourth length such that said second plurality of said resistive type heating elements is configured to maintain and equalize the temperature of said product to be rolled reached in said third zone, by supplying a determinate fourth heating power comprised between about 2 MW and about 8 MW.

11. Heating furnace as in claim 1, wherein said resistive type heating elements are disposed side by side, or adjacent, to each other so as to affect at least ½ of the internal cross-section of said tunnel, and in that said resistive type heating elements are preferably disposed above and/or below said product to be rolled, and possibly also on the sides of said product to be rolled, so as to be interposed between the internal surface of said tunnel and said product to be rolled.

12. Plant for the production of rolled products comprising at least one rolling train, wherein it comprises a heating furnace as in claim 1, which is disposed, along a rolling line, upstream of said rolling train.

13. Plant as in claim 12, wherein it comprises, upstream of said heating furnace, a casting machine to continuously feed a product to be rolled, wherein said plant is able to execute the rolling process at least in continuous, that is, endless mode.

14. Plant as in claim 12, wherein it comprises, along said rolling line, a pendular shear which is disposed between said casting machine and said heating furnace to cut to size said product to be rolled fed continuously, whereby said plant is able to execute the rolling process also in semi-endless, coil-to-coil or billet-to-billet mode.

15. Plant as in claim 12, in which, along said rolling line, a feed apparatus is disposed upstream of said heating furnace in order to cold feed said product to be rolled, and in which said rolling train comprises a plurality of roughing stands disposed close to the heating furnace, and a plurality of finishing stands disposed downstream of said roughing stands, wherein it comprises a heating furnace as in claim 1, disposed between said roughing stands and said finishing stands.
